(19) United States
(12) Patent Application Publication
(10) Pub. No.: US 2016/0129838 A1
(43) Pub. Date: May 12, 2016

(54) WIDE ANGLE REAR AND SIDE VIEW MONITOR

(71) Applicant: Garfield Ron Mingo, East Orange, NJ (US)

(72) Inventor: Garfield Ron Mingo, East Orange, NJ (US)

(21) Appl. No.: 14/926,092

(22) Filed: Oct. 29, 2015

Related U.S. Application Data
(60) Provisional application No. 62/078,172, filed on Nov. 11, 2014.

(51) Int. Cl. B60R 1/00; H04N 5/232; B60R 11/04; G06K 9/00

(52) U.S. Cl. CPC B60R 1/00; G06K 9/00791; H04N 5/23238; B60R 11/04; B60R 2300/802; B60R 2300/60; B60R 2300/107; B60R 2300/205

(57) ABSTRACT

A wide angle rear and side view monitor that eliminates blind spots. A roof mounted camera has a wide angle lens, preferably providing a viewing radius of 210 degrees. The images captured by the camera are presented on a display contained with a blind spot monitor.

### CROSS-REFERENCE TO RELATED APPLICATION

This application claims the benefit of priority of U.S. provisional application No. 62/078,172, filed Nov. 11, 2014, the contents of which are herein incorporated by reference.

### BACKGROUND OF THE INVENTION

The present invention relates to rearview cameras and sensors and, more particularly, to a wide angle rear and side view monitor.

Rearview cameras and sensors both can't react fast enough to prevent an accident. Side view mirrors stick out too far from the side of the vehicle and they can be costly to replace or to fix when broken. Rearview cameras and sensors both were made to prevent accidents, however they can't prevent accidents because an accident happens within seconds and these present devices can't react fast enough.

Moreover, conventional rear view and side view mirrors require the motor vehicle operator to scan to the left, front, and right in order to obtain situational awareness as to the proximity of other vehicle traffic. However, the limitations in these conventional systems, leave blind spots, or areas where the operator is unable to see approaching vehicles or adjacent vehicles, without physically changing their viewing perspective and the resultant reflections in the mirrors. Likewise, the physical positioning of conventional rear view mirrors in the vehicles windshield may partially obstruct a motor vehicle operator's visibility of hazards they may be approaching.

As can be seen, there is a need for a wide angle camera that provides a display for a motor vehicle operator to view around the car environment to detect potential hazards.

### SUMMARY OF THE INVENTION

In one aspect of the present invention, an apparatus for eliminating blind spots in a motor vehicle is provided. The apparatus comprises: a camera mounted to a roof of the motor vehicle, the camera having a wide angle lens to capture the operating environment of the vehicle to the left, aft, and right of the vehicle; a monitor mounted in the interior of the vehicle, the monitor comprising a display panel to display images of the operating environment received by the camera. Preferably, the wide angle lens has a viewing radius of about 210 degrees, and the viewing radius may be divided along a longitudinal centerline of the vehicle. In some embodiments, the camera is elevated from the roof of the motor vehicle, preferably between about 6 to 12 inches. More preferably, the camera is mounted at a point aft the B-pillar of an automotive vehicle.

In some aspects of the invention, the monitor is mounted in a dashboard of the motor vehicle. The monitor may monitor comprise controls, operable to change the appearance of the displayed images of the operating environment. The camera may communicate via a wired connection to the monitor. In other aspects of the invention, the camera communicates via a wireless connection to the monitor.

These and other features, aspects and advantages of the present invention will become better understood with reference to the following drawings, description and claims.

### BRIEF DESCRIPTION OF THE DRAWINGS

FIG. 1 depicts a display in the dashboard of a motor vehicle.

FIG. 2 is an overhead perspective view of a motor vehicle with an embodiment of a wide angle camera of the present invention.

FIG. 3 is an overhead plan view of a motor vehicle with a roof mounted wide angle camera.

FIG. 4 is a detail view of a camera and wide angle lens.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rearview monitor system that provides a wide angle view of the aft and sides of a motor vehicle, such as a car, truck, sport utility vehicle, and the like. Utilizing the apparatus of the present invention, a motor vehicle operator will be able to see everything around their vehicle, and more particularly the blind spots to the left and right rear and sides of the vehicle, just by looking at a single monitor that will provide the operator a wide angle view of the vehicle's surroundings in real time.

As stated previously, rearview cameras and sensors both were made to prevent accidents, however they can't prevent accidents because an accident happens within seconds and the present devices can't react fast enough. According to aspects of the present invention, by providing the vehicle operator the ability to see a wide angle view, preferably 210 degrees around their vehicle, the vehicle operator will now have a chance to see previously hidden hazards and thereby react fast enough to prevent an accident.

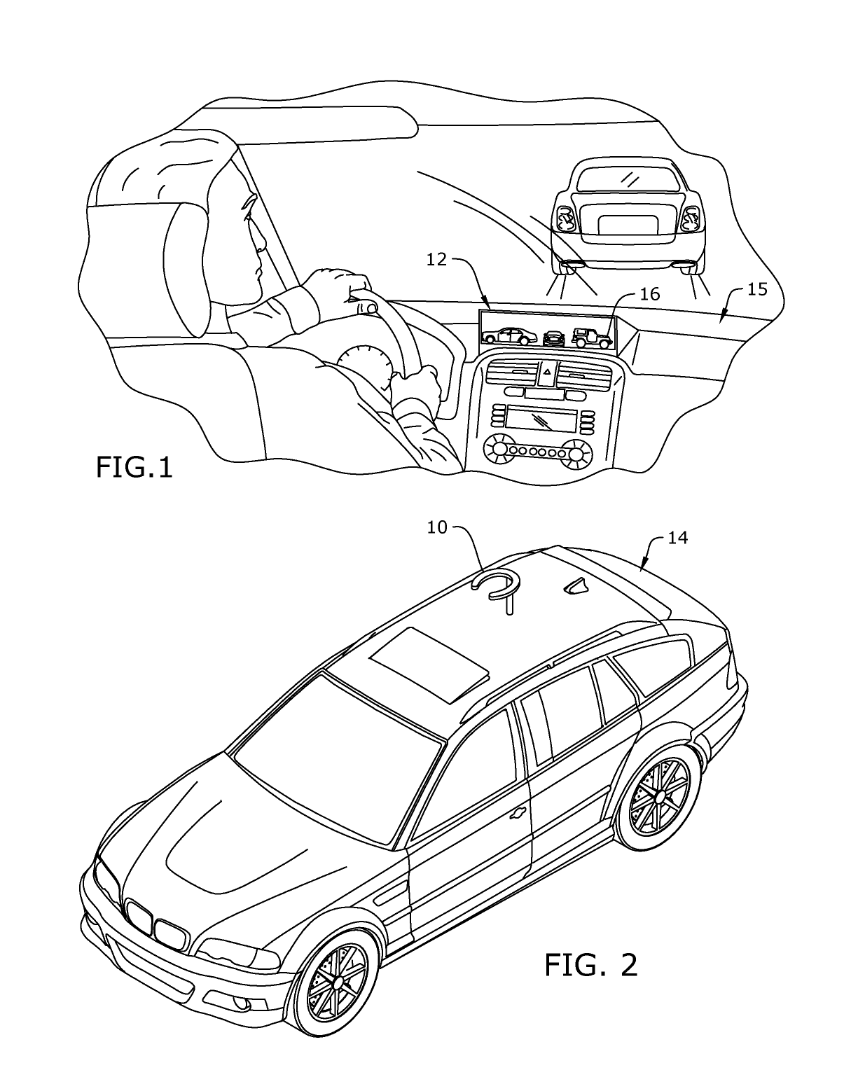

The apparatus of the present invention comprises a monitor 12 and a wide angle camera 10. In a preferred embodiment of the invention, the camera 10 will have a field of view, or viewing radius of about 210 degrees towards the rear and sides of the vehicle. More preferably, the viewing radius is divided along a longitudinal centerline of the vehicle 14. As best seen in reference to FIGS. 1 and 2, the monitor 12 may preferably be embedded or attached to a dashboard 15 located in the interior of a motor vehicle 14.

By positioning the monitor 12 on the dashboard 15, the operator is provided a greater field of view through the windshield, without the obstruction presented by a conventional rear view mirror. The monitor 12 may be centered in the dashboard 15, or preferably in positioned closer to an operator's Alternatively, the monitor may be positioned in place of the rear view mirror, for operators that prefer, as part of their normal scanning patterns to view what is behind them in that location.

The monitor 12 comprises a video display panel 16, to display images received from the wide angle camera 10. The image presented on the display panel 16 may be a composite view of the operating environment to the left, aft, and right of the vehicle 14. The monitor 12 may be configurable to provide a menu of viewing options and perspectives, based on an operator's preference, such as a panoramic view, a fish-eye view, or other configurations so that the images from the sides of the vehicle are presented to provide situational awareness more aligned with the direction of travel of the vehicle 14.

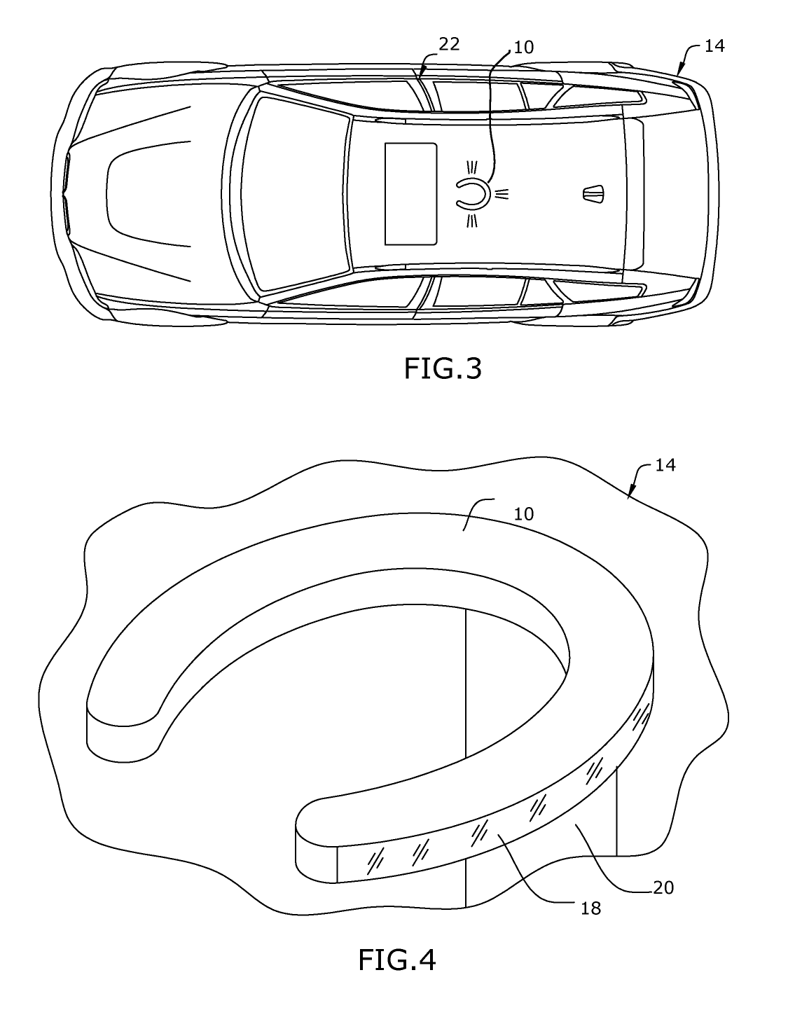

As seen in reference to FIGS. 3 and 4, the wide angle camera 10 has a wide angle lens 18 that receives and transmits video images to the monitor 12. The wide angle camera 10 is preferably mounted on top of the vehicle 14, and more preferably the camera 10 should be elevated with respect to the top of the vehicle 14, so as to avoid substituting the blind spot from traditional side view mirrors, to one where the top of the vehicle 14 obstructs visibility of traffic conditions present to the sides of the vehicle 14. More preferably, the camera 10 should be mounted on a post or pedestal 20 at a point just aft of the B-pillar 22 of the vehicle 14 so that the images detected by the camera 10 will overlap the operator's peripheral vision out the side windows of the vehicle 14. The pedestal 20 should position the camera 10 between about 6 and 12 inches above the roof of the vehicle 14.

The video signals produced by the camera 10 may be communicated via a wired or wireless connection to the monitor 12.

Simply by installing these two components onto the vehicle 14 will alleviate the operator from ever having a blind spot and it will give the operator the chance to react faster than possible with an out dated side and rear view mirror. The operator's reaction time will also be better because the operator will only have to look in one location to receive situational awareness in the environment surrounding the vehicle, without the need turning their head to decide what their next move is while driving.

It should be understood, of course, that the foregoing relates to exemplary embodiments of the invention and that modifications may be made without departing from the spirit and scope of the invention as set forth in the following claims.

What is claimed is:

1. An apparatus for eliminating blind spots in a motor vehicle, comprising:
a camera mounted to a roof of the motor vehicle, the camera having a wide angle lens to capture the operating environment of the vehicle to the left, aft, and right of the vehicle;
a monitor mounted in the interior of the vehicle, the monitor comprising a display panel to display images of the operating environment received by the camera.

2. The apparatus of claim 1, wherein said wide angle lens has a viewing radius of about 210 degrees.

3. The apparatus of claim 2, wherein the viewing radius is divided along a longitudinal centerline of the vehicle.

4. The apparatus of claim 1, wherein the camera is elevated from the roof of the motor vehicle.

5. The apparatus of claim 4, wherein the camera is elevated between about 6 to 12 inches.

6. The apparatus of claim 1, wherein the camera is mounted at a point aft the B-pillar of an automotive vehicle.

7. The apparatus of claim 1, wherein the monitor is mounted in a dashboard of the motor vehicle.

8. The apparatus of claim 1, wherein the monitor comprises controls, operable to change the appearance of the displayed images of the operating environment.

9. The apparatus of claim 1, wherein the camera communicates via a wired connection to the monitor.

10. The apparatus of claim 1, wherein the camera communicates via a wireless connection to the monitor.
